(19) United States
(12) Patent Application Publication
(10) Pub. No.: US 2016/0031374 A1
(43) Pub. Date: Feb. 4, 2016

(54) Rimless Blind Spot Mirror

(71) Applicant: Yi Huei Jen, Irvine, CA (US)

(72) Inventor: Yi Huei Jen, Irvine, CA (US)

(21) Appl. No.: 14/446,253

(22) Filed: Jul. 29, 2014

(51) Int. Cl. B60R 1/08

(52) U.S. Cl. CPC B60R 1/082

(57) ABSTRACT

A blind spot reduction apparatus that will sit flush on external mirrors on a vehicle on which it is adhered onto as well as feature a rimless, seamless look that is not only aesthetically pleasing, but also functional.

### BACKGROUND

The need for drivers to view and identify objects and vehicles behind their own vehicle quickly became apparent after the advent of motorized vehicle travel. For this reason, rear view mirrors were created to provide an apparatus to alleviate this need. Presently, most vehicles are equipped with an internal rearview mirror and two external rearview mirrors. The issue with these external mirrors though is a blind spot is present, which requires a driver to look over their shoulder and hence momentarily lose vision of what is happening ahead of their vehicle. So to solve this issue, add on blind spot mirrors were created, and when placed at an appropriate location on the external mirrors, eliminates most, if not all, of the possible blind spots a driver experiences behind them. A number of add on blind spot mirrors have been created and are usually convex mirrors that are attached on the external mirror via adhesive material. These add on mirrors have edges that are typically never flush with the external mirror and also have a rim that is not only aesthetically unpleasing, but also creates a gap that can cause some distortion. Therefore, there is a need for an add on blind spot mirror that solves the aforementioned issues.

### FIELD OF INVENTION

The present invention relates to an add on for vehicles external mirrors that will alleviate side and rear blind spots. Specifically, this add on will be rimless blind spot mirrors with an edge that sits flush with the external mirror it is adhered onto.

### SUMMARY OF INVENTION

The invention consists of a convex mirror with no outer rim that when adhered onto the external mirror of a vehicle, aids the driver in eliminating blind spots. Furthermore, the mirror which will be convex in one side will be flat on the opposite side with a slot sized for an adhesive material to fit into and secure the blind spot mirror on the external mirror while remaining flush and appearing seamless.

### DESCRIPTION OF DRAWINGS

The present invention, Ankle Storage Pouch, may best be understood by reference to the following description taken in connection with the accompanying drawings which reference numbers designate the parts throughout the figures to enable the reader to understand the reasoning behind and the application of the present invention. Even though specific configurations are shown, it should be noted that these are merely for illustrative purposes.

FIG. 1 is a rearview illustration of the present invention, Rimless Blind Spot Mirror (1) showing the non-reflective surface (3) and the adhesive slot (7)

FIG. 2 is a rear side view illustration of the present invention (1) showing the reflective surface (2) and the non-reflective surface (3) with the adhesive slot (7).

FIG. 3 is an illustration of the adhesive pad (4) that will be attached to the adhesive slot (7), from FIG. 1, on the non-sticky side (6) to allow the sticky side (5) to be exposed.

FIG. 4 is a front view illustration of the present invention (1) showing the reflective surface (2).

FIG. 5 is an illustration of the present invention (1) attached, with its reflective surface (2) visible, onto a side view external mirror (8). This figure, although not visibly shown, features adhesive pad (2) attached in adhesive slot (7) on its non-sticky side (6) and is holding the present invention (1) onto the side mirror (8) via sticky side (5). The present invention (1) has edges that sit flush with the side mirror (8).

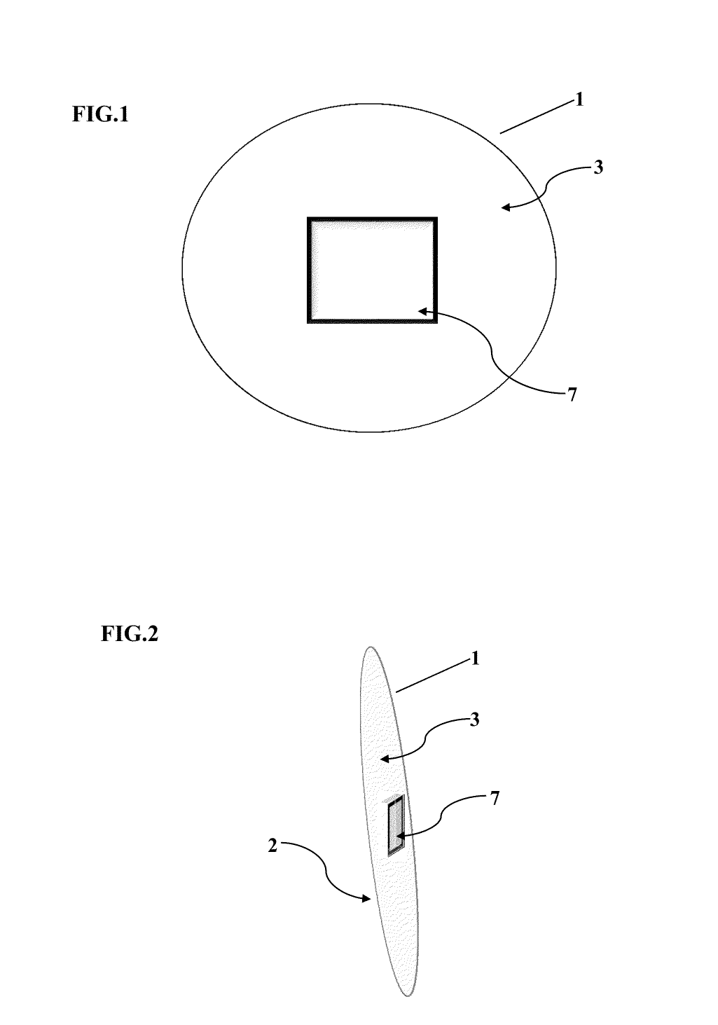

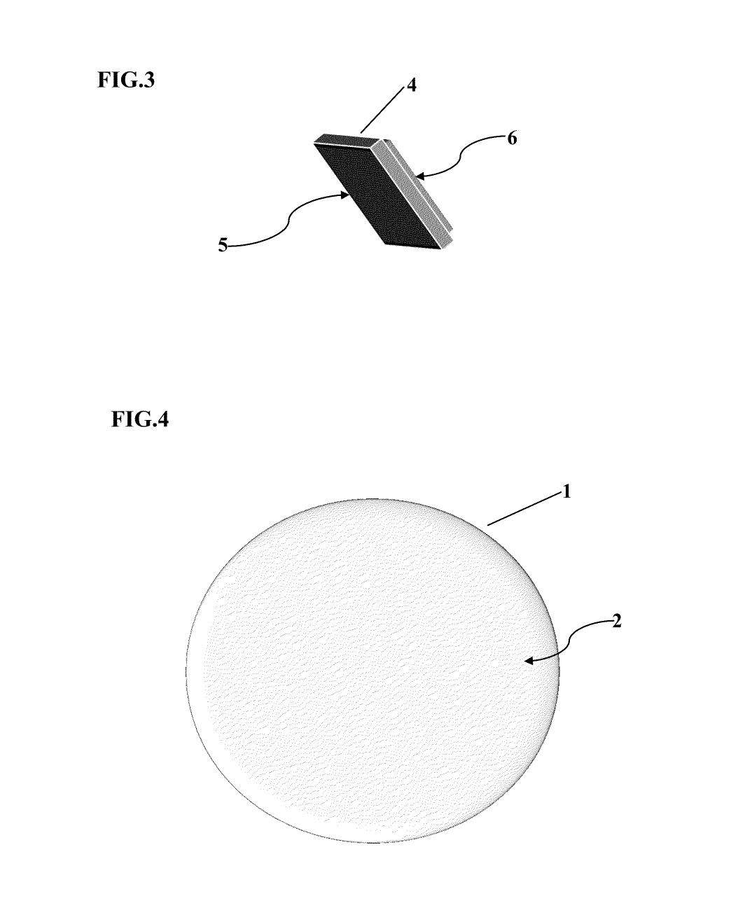

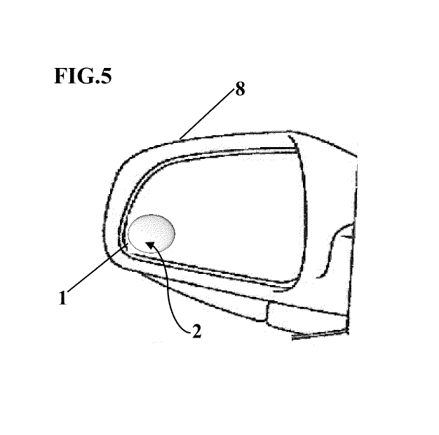

1) A blind spot mirror comprising;
A convex mirror; and
An adhesive pad;
Wherein said adhesive pad is attached to said convex mirror.

2) A convex mirror from claim 1 further comprising;
A rimless outer edge
A reflective side
A non-reflective side;
Wherein said non reflective side has a slot

3) The adhesive pad, from claim 1, further comprising;
A sticky Side
A non sticky side attached to the non-reflective side at said slot from claim 2.
